(19) United States
(12) Patent Application Publication
(10) Pub. No.: US 2013/0272810 A1
(43) Pub. Date: Oct. 17, 2013

(54) THREADER POWER ADAPTER

(71) Applicant: KELLEY OILFIELD SERVICES, INC., Farmington, NM (US)

(72) Inventors: Todd Kelley, Farmington, NM (US); Gabriel Estrada, Farmington, NM (US)

(73) Assignee: Kelley Oilfield Services, Inc., Farmington, NM (US)

(21) Appl. No.: 13/855,752

(22) Filed: Apr. 3, 2013

Related U.S. Application Data
(60) Provisional application No. 61/622,738, filed on Apr. 11, 2012.

(51) Int. Cl. B23G 1/00; F16D 1/076

(52) U.S. Cl. CPC B23G 1/00; F16D 1/076
USPC 408/147; 464/182

(57) ABSTRACT

A threader power adapter includes a power shaft having a first longitudinal axis extending through proximal and distal ends and an adapter shaft having a second longitudinal axis coupled to the distal end of the power shaft. The adapter is configured for insertion into a threader handle socket along a first axis and insertion into a driver along a second axis such that application of a torque to the adapter about the second axis causes rotation of the threader assembly about a third axis. With a disclosed method, the threader power adapter is coupled with a threader assembly and the threader assembly is placed on the cylindrical member. A driver is coupled with the threader adapter and a torque is applied to the threader adapter with the driver to turn the threader assembly about a central axis to cut threads in the exterior surface of the cylindrical member.

### PRIORITY CLAIM

This application claims the benefit of U.S. Provisional Patent Application No. 61/622,738 titled “Threading tool attachment” of Kelley, et al. filed on Apr. 11, 2012, and incorporated by reference for all that is disclosed as though fully set forth herein.

### BACKGROUND

Joining two or more pipes or other cylindrical members to one another is often by threaded members. When a cylindrical member is not already provided with threads, a user may thread the cylindrical member using one of a variety of threaders capable of cutting threads into the exterior surface of the cylindrical member. One type of threader is known as a receding pipe threader.

Receding pipe threaders (and other types of threaders) are typically operated manually. Manual operation is by the user repeatedly applying large amounts of force, and sometimes causes a user to stand in awkward positions in order to turn the pipe threader. For example, manually operating a receding pipe threader may need 84 or more, 90 to 180 degree strokes to thread a 2 inch pipe. This is time consuming, labor-intensive, and can be unsafe.

### BRIEF DESCRIPTION OF THE DRAWINGS

FIG. 1A is a perspective view of an example threader power adapter.

FIG. 1B is an exploded perspective view of the threader power adapter of FIG. 1A.

FIG. 2 is a perspective view of an example threader power adapter coupled with a threader assembly wherein adapter power shaft revolves around threader assembly central axis in a clockwise orientation.

FIG. 3 is perspective view of an example threader power adapter coupling a driver with a threader assembly.

FIG. 4 is a flow diagram of a method for threading a pipe with a threader assembly and driver coupled by an example threader power adapter.

### DETAILED DESCRIPTION

A threader power adapter and methods are disclosed. In an example, the threader power adapter enables cutting of threads into an exterior of a pipe or other cylindrical member in a manner which substantially reduces or altogether eliminates the manual intensity of the task. An example threader power adapter may be provided to couple a threader assembly with a power driver. Power threading with the threader power adapter reduces the potential for injury, enhances the ergonomics of a repeated task, increases proficiency of the repeated task, and offers cost savings over time (e.g., due to the speed with which threading tasks can be completed). An example threader power adapter affords a transmission of toque between a power driver and a threader assembly.

Before continuing, it is noted that as used herein, the terms “includes” and “including” mean, but is not limited to, “includes” or “including” and “includes at least” or “including at least.” The term “based on” means “based on” and “based at least in part on.” Additionally, while the term “threader assembly” has been used herein it should be noted that this term is meant to additionally encompass “threading tool”, “adjustable threading tool”, “threader”, “receding pipe threader”, and various components of a threader assembly including “threader ratchet assemblies.”

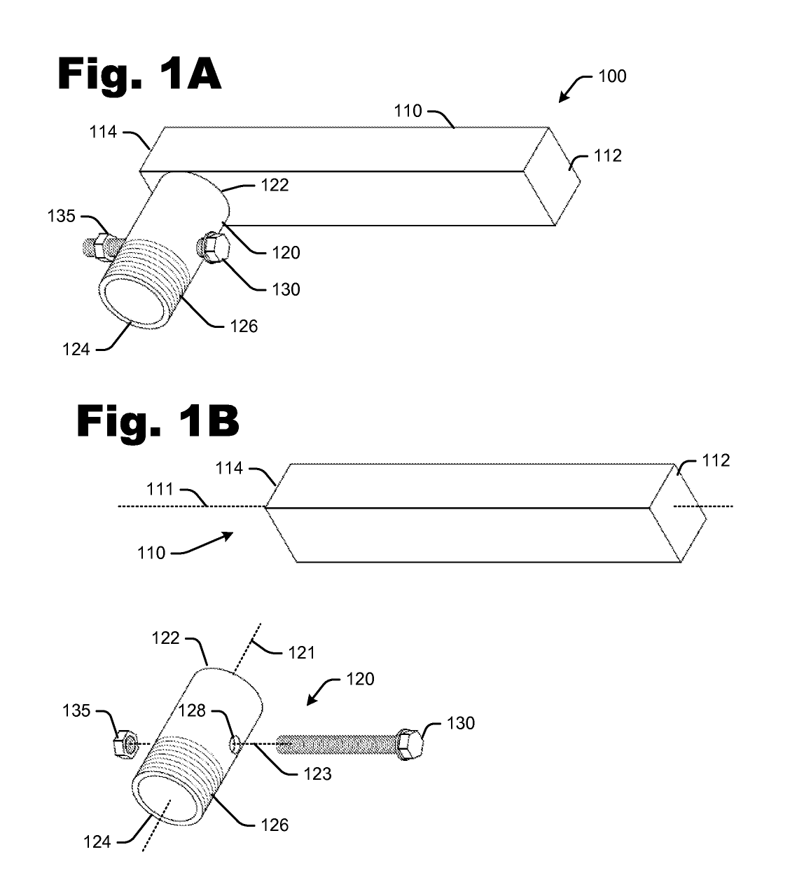

An example threader power adapter 100 is depicted in FIG. 1. The example threader power adapter 100 is shown as it may include a power shaft 110 having a first longitudinal axis 111 extending through proximal 112 and distal 114 ends and an adapter shaft 120 having a second longitudinal axis 121 extending through proximal 122 and distal 124 ends.

In some examples, power shaft proximal end 112 has a rectangular cross section (although other shapes are also contemplated). In an example, power shaft 110 may be formed of about ⅞″ steel solid square stock cut having a length of about 6″. However, power shaft 110 and its respective proximal 112 and distal 114 ends may be provided in any of a variety of shapes and/or sizes conducive to receiving an engaging member of a driver for effective power transfer between the driver and the power shaft.

Furthermore, power shaft 110 may be provided in any of a variety of dimensions conducive to mating with a driver for effectively transferring power between the driver and power shaft 110 and may be formed of any of a variety of durable materials capable of resisting plastic deformation under torsional forces that may be applied when adapter 100 is in use between a power driver and a threader assembly.

Adapter shaft 120 may include external threads 126 formed near adapter shaft distal end 124 to facilitate screwing of adapter shaft 120 into a threader assembly to enable use with a power drive. In some examples, adapter 100 may replace a manually operated handle. A through hole 128 may also be provided in adapter shaft 120 between proximal 122 and distal 124 ends and configured to receive a fastener assembly. In some examples, through hole 128 includes a longitudinal axis 123 extending approximately perpendicular to longitudinal axis 121.

In some examples, adapter shaft includes a circular or toroidal cross section. In an example, adapter shaft 120 may be formed from about a 1 and ¾ inch long, about a ¾ inch diameter cold rolled solid steel and threading 126 may be provided at a height of about 1 inch from distal end 124. However, adapter shaft 120 and its respective proximal 122 and distal 124 ends may be provided in any of a variety of shapes conducive to engaging a threader assembly for effective torque transfer between the power shaft and the threader assembly. Furthermore, adapter shaft 120 may be provided in any of a variety of dimensions conducive to mating with a threader assembly for effectively transferring torque between power shaft 110 and a threader assembly and may be formed of any of a variety of durable materials capable of resisting plastic deformation under torsional forces that may be applied when adapter 100 is in use between a power driver and a threader assembly.

A fastener assembly may improve engagement of adapter shaft 120 with a threader assembly. In an example, a fastener assembly is provided as a bolt 130 for placement in through-hole 128 and a nut 135. With bolt 130 inserted in through-hole 128, bolt 135 may be threaded onto bolt 130 to apply a gripping pressure to exterior surface of adapter shaft 120 thereby reinforcing engagement of adapter shaft 120 with a threader assembly. Any of a variety of bolts may be provided for use with adapter shaft 120 including a grade 80, 5/16 inch by a 2 inch bolt. Further, any of a variety of nuts configured to threading onto bolt 130 may be provided. In some examples, a fastener assembly may further include a washer such as a lock washer.

It is noted that an example of adapter 100 may include either of threading 126 or a fastener assembly or both.

Proximal end 122 of adapter shaft 120 is coupled with distal end 114 of power shaft 110 to facilitate a transmission of torque therebetween. Longitudinal axes 111 and 121 extend at angles to one another when the two shafts are coupled. In an example, axes 111 and 121 are oriented perpendicular to one another.

In an example, power shaft 110 is formed integral with adapter shaft 120. In another example, power shaft 110 is welded to adapter shaft 120 using a 7018 welding rod (e.g., by a certified welder). In other examples, power shaft 110 may be removably coupled with adapter shaft 120.

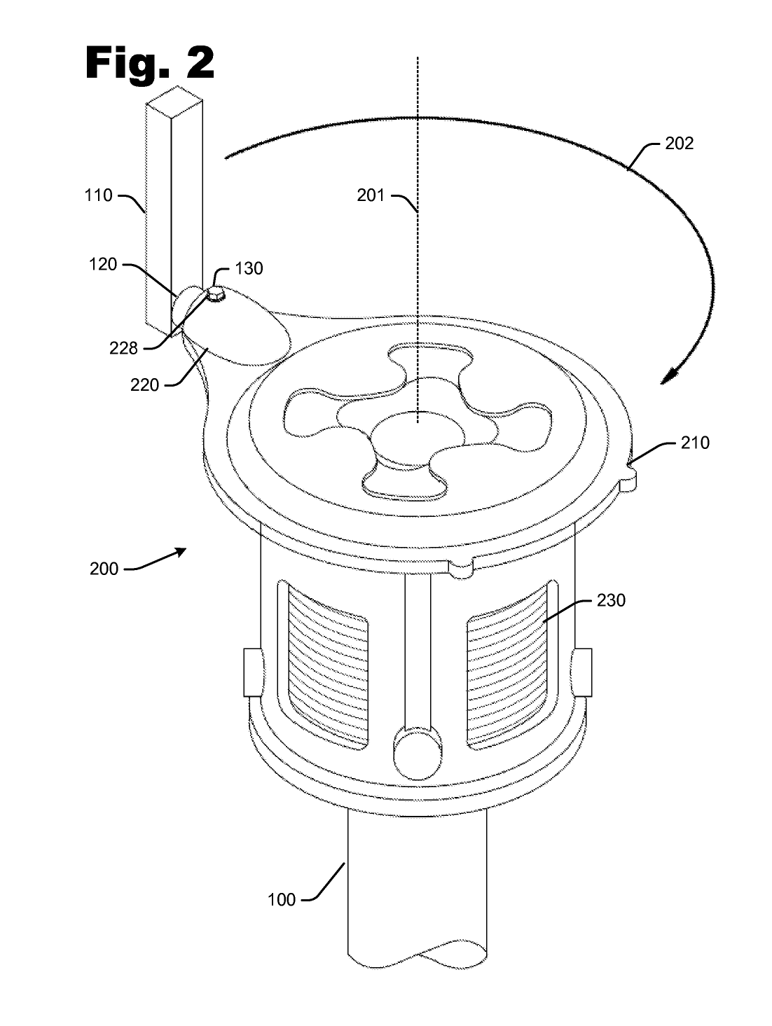

An example adapter is illustrated in engagement with a threader assembly 200 in FIG. 2. Threader assembly 200 may include a ratchet portion 210 in the shape of a circular disc or ring, a handle socket 220 and a thread cutter 230. Ratchet portion 210 of threader assembly 200 includes a central axis of revolution 201. Handle socket 220 is oriented perpendicular to axis 201. Thread cutter 230 includes a plurality of cutting blades or teeth at its interior for cutting threads into exterior of an example pipe 400 or other cylindrical member, e.g., when operated to rotate as illustrated by arrow 202. Adapter 100 is usable with, for example, a 65R series receding threader. However, adapter 100 is not limited to use with a 65R series threader. Nor is threader power adapter 100 limited to use with threader assembly 200, as illustrated.

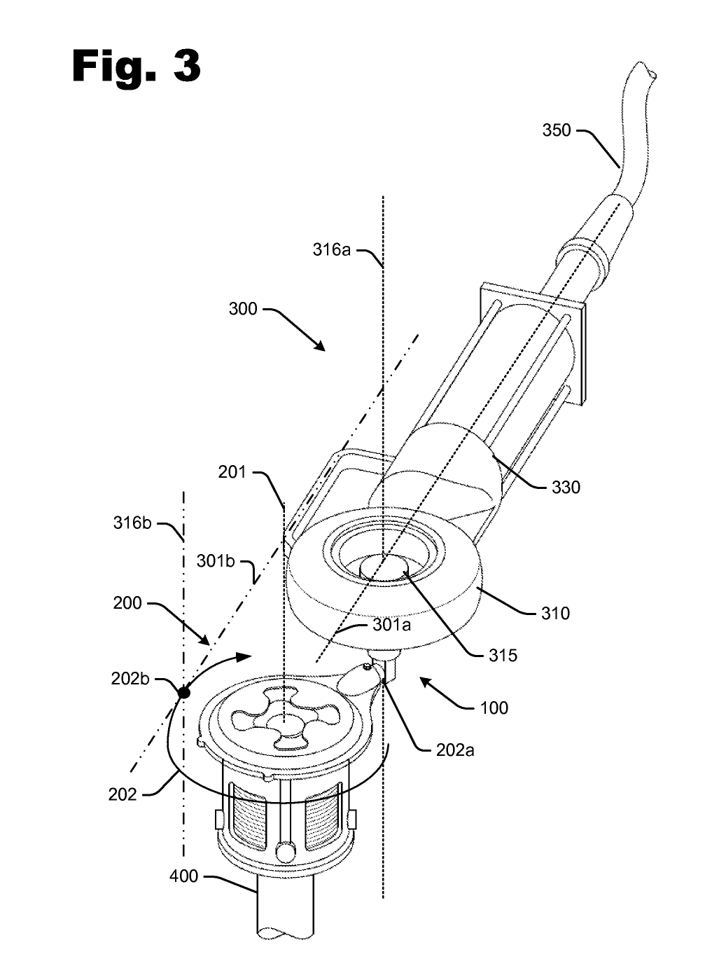

With reference to FIG. 3, a driver 300 for use with examples of the disclosed adapter may include a drive head 310 with a rotary drive 315 (e.g., operated to rotate as illustrated by arrow 202), a housing or handle 330 and a power cord 350. Any suitable power driver may be used, including but not limited to a pneumatic power driver, an electrical power driver, or a gas power driver. Driver 300 may be, for example, a model 700 power driver having a model 774 square drive fitting.

Operation may also be understood with reference to FIG. 3. It is noted that in this example, the adapter 100 is mounted fixedly to the threader assembly 200 (e.g., as described above for FIG. 2). That is, the adapter 100 does not move relative to the threader assembly.

In this example, operating the driver 300 causes the rotary drive 315 to rotate internal to the driver 300 about a rotary drive axis 316a (e.g., its own axis). The handle 330 of the driver 300 is held such that the rotary drive axis 316a points in substantially the same direction during operations. Of course, minor variations may be tolerated, but not to such an extent that the handle 330 of driver 300 rotates fully about axis 316a and does not cause the threader assembly 200 to orbit the axis 201 of pipe 400.

When attached to the adapter 100 (which is fixedly attached to the threader assembly 200), the driver 300 thus moves or “orbits” the adapter 100 (and hence the attached threader assembly 200) in the direction illustrated by arrow 202 (or opposite direction), such that the threader assembly 200 is rotated about pipe 400. During rotation, the blades or teeth in threader assembly 200 form threads in the pipe 400. The direction of orbit 202 may be reversed to automatically remove the assembly, or the driver 300 may be removed from the threader assembly 200 and the threader assembly 200 manually removed (e.g., unscrewed from the pipe 400).

It is noted in this example operation that the adapter 100 does not rotate about socket 220 (see FIG. 2), but rather remains in a fixed or upright position (the term “upright” being relative to the drawing). Nor does adapter 100 rotate about its own axis. Instead, the adapter 100 rotates (along with threader assembly 200) about a central axis 201 of the threader assembly 200 (and hence the concentric axis of the pipe 400). That is, the rotary drive axis 316a (also the axis of the adapter 100 in this example) orbits axis 201 such that the rotary drive axis at any point on orbit 202 is parallel to the rotary drive axis at any other point on the orbit 202 (e.g., axis 316a at point 202a and axis 316b at point 202b on orbit 202), and perpendicular to a longitudinal axis of the handle 330 of the driver 300 (axis 301a at point 202a on the orbit 202, and axis 301b at point 202b on the orbit 202).

Before continuing, it should be noted that the specific dimensions and part numbers are illustrative only and not intended to be limiting. The examples described above are provided for purposes of illustration, and are not intended to be limiting. Other devices and/or device configurations may be utilized to carry out the operations described herein.

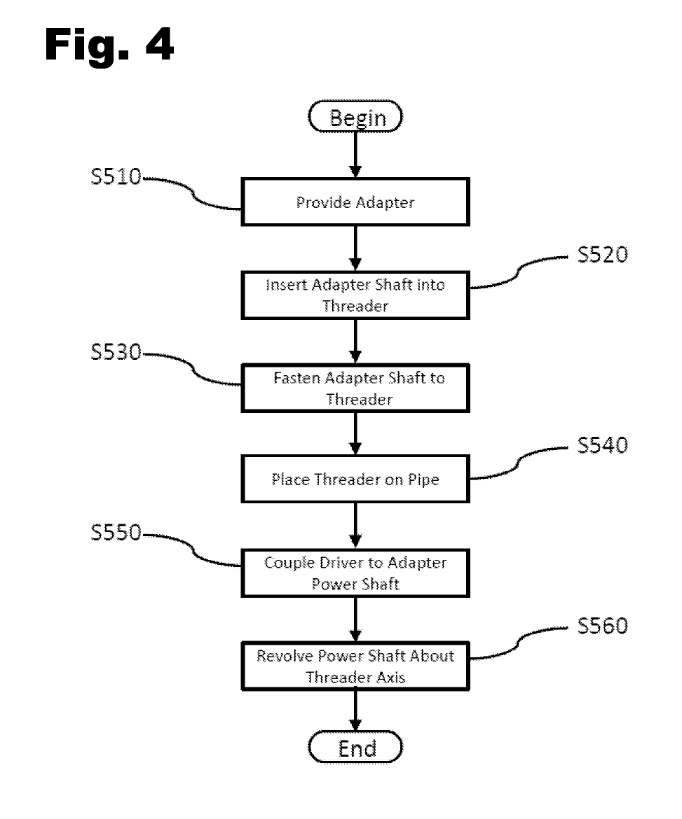

An example method for forming threads in an exterior surface of a cylindrical member such, as a pipe, is now described with reference to the flowchart of FIG. 4.

To begin, in step S510, a user provides an adapter 100 (FIG. 3) including a power shaft 110 having proximal and distal ends and an adapter shaft 120 coupled with the power shaft 110.

Adapter shaft 120 is inserted into handle socket 220 provided within a threader assembly 200 (FIG. 2) in step S520. Threads 126 of adapter shaft 120 engage internal threads provided in handle socket 220 as adapter shaft 120 is rotated into threader handle socket 220. A fastener 130 may be inserted through holes 228 provided on threader assembly 200, through adapter shaft through holes 128 and provided with a nut 135 threaded onto its distal end thus securing adapter shaft 120 within handle socket 220 in step S530.

With adapter 100 coupled to threader assembly 200, in a step S540, a user places threader assembly 200 on a pipe 400 or other cylindrical member to which the user wishes to provide external threads.

With the threader assembly and adapter provided to the pipe, a driver 300 is coupled with power shaft 110 in step S550. While engaged with threader assembly 200 through adapter 100, driver 300 is spaced apart away from both longitudinal axis 201 and the upper surface of threader assembly 200.

In step S560, power shaft 110 is revolved about central axis 201 by application of a torque to power shaft 110 using driver 300. With driver 300, a torque is applied about longitudinal axis 111 but spaced-apart from and parallel to central axis 201. In drivers including an electrical motor, electrical power is supplied to the motor through a power cord 350 to provide a torque.

By revolving the power shaft 110 about central axis 201, threader assembly 200 is rotated about central axis 201 to cut threads in the exterior surface of pipe 400 or other cylindrical member.

According to this example method, a user does not need to pause and re-grip a handle during a revolution of the threader assembly on the cylindrical member. The threader assembly may be continuously rotated about its central axis until threading is complete. For purposes of non-limiting illustration, a 2 inch pipe can be readily threaded with 11 full revolutions.

The operations shown and described herein are provided to illustrate example implementations. It is noted that the operations are not limited to the ordering shown. Still other operations may also be implemented.

While described as being for use to couple a threader assembly with a power driver such as 300, an adapter in accordance with the examples disclosed may also be used to facilitate coupling of a threader assembly with a handle offering enhanced mechanical advantage to a user during manual threading.

It is noted that the examples shown and described are provided for purposes of illustration and are not intended to be limiting. Still other examples are also contemplated.

1. A threader power adapter, comprising:
a power shaft having a first longitudinal axis extending through proximal and distal ends;
an adapter shaft having a second longitudinal axis extending through proximal and distal ends, the adapter shaft being coupled to the distal end of the power shaft; and
a fastener assembly configured to selectively secure the adapter shaft to a threader assembly.

2. The adapter of claim 1, wherein the adapter shaft is coupled to the power shaft distal end by the proximal end of the adapter shaft.

3. The adapter of claim 1, wherein the power shaft and adapter shaft are coupled such that the second longitudinal axis extends at an angle to the first longitudinal axis.

4. The adapter of claim 3, wherein the angle is approximately 90 degrees.

5. The adapter of claim 1, further comprising external threads formed on the adapter shaft near the adapter shaft distal end.

6. The adapter of claim 1, further comprising a through hole provided in the adapter shaft between the proximal and distal ends and configured to receive the fastener assembly.

7. The adapter of claim 6, wherein the through hole defines a longitudinal axis extending approximately perpendicular to the second longitudinal axis.

8. The adapter of claim 1, wherein the power shaft is formed integral with the adapter shaft.

9. The adapter of claim 1, wherein the power shaft is removably coupled with the adapter shaft.

10. The adapter of claim 1, wherein the power shaft proximal end includes a rectangular cross section.

11. A system for adapting a threader assembly for use with a driver, comprising:
an adapter configured for insertion into a threader handle socket along a first axis and insertion into a driver along a second axis such that application of a torque to the adapter about the second axis causes rotation of the threader assembly about a third axis; and
a fastener assembly configured for insertion through a portion of the adapter to secure the adapter to the threader assembly;
wherein the third axis is parallel to and spaced apart from the second axis.

12. The system of claim 11, wherein the third axis is perpendicular to the first axis.

13. The system of claim 11, wherein the second axis is perpendicular to the first axis.

14. A method for forming threads at an exterior surface of a cylindrical member such as a pipe, comprising:
providing an adapter including a power shaft having proximal and distal ends and an adapter shaft having external threads and a through hole;
receiving the adapter shaft into a handle socket provided within a threader assembly;
receiving a fastener through the adapter shaft through hole and holes provided on the threader assembly;
wherein the threader assembly is positioned on the cylindrical member, and a a driver is coupled with the power shaft;
wherein applying a torque to the power shaft with the driver causes the power shaft to revolve about a central axis of the threader assembly; and
wherein the threader assembly is rotated about the central axis to cut threads in the exterior surface of the cylindrical member.

15. The method of claim 14, wherein applying a torque to the power shaft with the driver further comprises supplying electrical power wherein the driver is motorized.

16. The method of claim 14, further comprising threading a nut onto the fastener to secure the adapter shaft within the handle socket.

17. The method of claim 14, wherein the torque is applied about an axis coincident with the longitudinal axis of the power shaft and parallel to the central axis of the threader assembly.

18. The method of claim 14, wherein the torque is applied about an axis parallel to but spaced apart from the threader assembly central axis.

19. The method of claim 14, wherein the power shaft is provided approximately perpendicular to the adapter shaft.

20. The method of claim 14, wherein the driver includes a longitudinal axis spaced apart from the threader assembly in a direction parallel to the threader assembly central axis.
